(19) United States
(12) Patent Application Publication
(10) Pub. No.: US 2026/0289326 A1
(43) Pub. Date: Sep. 24, 2026

(54) SYSTEM AND METHOD FOR AUTOMATED MACHINE LEARNING MODEL TRAINING

(71) Applicant: Profformance Technologies Private Limited, Gurugram (IN)

(72) Inventor: Sahil Narain, Gurgaon (IN)

(73) Assignee: Profformance Technologies Private Limited, Gurugram (IN)

(21) Appl. No.: 19/567,106

(22) Filed: Mar. 14, 2026

(30) Foreign Application Priority Data
Mar. 18, 2025 (IN) 202511024300

(51) Int. Cl. G06N 3/0985

(52) U.S. Cl. CPC G06N 3/0985

(57) ABSTRACT

A system for automated machine learning model training comprising processor configured to receive multi-modal training data and user-defined parameters through end-user abstraction interface, autonomously determine machine learning domain applicable to multi-modal input data by analyzing data annotations. Autonomously prune redundant data elements from multi-modal input data to generate training dataset, automatically identify hyperparameters for training dataset, automatically split multi-modal input data into plurality of data groups using dynamically determined split ratios. Select a machine learning framework and neural network architecture based on the determined machine learning domain. Perform batch normalization on training dataset, train machine learning model using training dataset, selected framework and architecture, and identified hyperparameters, training includes dynamic adjustment of learning rates and evaluate machine learning model during training using validation data from plurality of data groups, wherein training is terminated when loss function indicates minimal reduction in difference between actual and predicted value.

### TECHNICAL FIELD

The present disclosure relates to the field of automated machine learning systems, more specifically to a system and a method for the automated machine learning model training.

### BACKGROUND

Machine learning models are widely utilized in various applications, such as text classification, image recognition, object detection, data prediction, language understanding, text generation, and the like. However, training a machine learning model involves multiple complex tasks, including selecting the required model based on the multi-modal input data, preprocessing data, fine-tuning various settings (such as hyperparameters, optimizers, learning rate), and evaluating performance. Conventionally, the tasks in training the machine learning model require manual effort and expertise that makes the training process time-consuming and challenging.

Certain attempts have been made to automate the machine learning training, such as by using model selection and hyperparameter tuning libraries and the like. However, conventional systems lack the ability to analyse the multi-modal input data, determine the required machine learning domain, and optimize the training pipeline without manual intervention. Most of the conventional systems rely on predefined workflows, require users to specify parameters manually, and typically are not designed to handle multi-modal data, leading to inefficiencies and suboptimal machine learning model performance. Thus, there exists a technical gap of how to trivially train a machine learning model automatically without manual intervention.

Therefore, in light of the foregoing discussion, there exists a need to overcome the aforementioned drawbacks associated with the conventional systems utilized for training the automated machine learning model.

### SUMMARY

The present disclosure provides a system and a method for an automated machine learning model training. The present disclosure provides a solution to the technical problem of how to trivially train a machine learning model automatically without manual intervention. An aim of the present disclosure is to provide a solution that overcomes at least partially the problems encountered in the prior art and provide the system for the automated machine learning model training that processes the multi-modal data input while automatically determining the required training method for the machine learning model.

One or more objectives of the present disclosure are achieved by the solutions provided in the enclosed independent claims. Advantageous implementations of the present disclosure are further defined in the dependent claims.

In one aspect the present disclosure provides the system for automated machine learning model training that includes a processor configured to receive multi-modal input data and user-defined parameters through an end-user abstraction interface. Furthermore, the processor is configured to autonomously determine a machine learning domain applicable to the multi-modal input data by analyzing data annotations, autonomously prune redundant data elements from the multi-modal input data to generate a training dataset, automatically identify hyperparameters for the training dataset, automatically split the multi-modal input data into a plurality of data groups using dynamically determined split ratios. Moreover, the system selects an appropriate machine learning framework and neural network architecture based on the determined machine learning domain, performs batch normalization on the training dataset, trains a machine learning model using the training dataset, the selected framework and architecture, and the identified hyperparameters, wherein the training includes dynamic adjustment of learning rates and real-time evaluation of the machine learning model during training using validation data from the plurality of data groups, wherein training is terminated when a loss function indicates the minimal reduction in a difference between an actual and a predicted values over a plurality of training iterations.

Advantageously, the system is configured to provide the automated and optimized method for training the machine learning models across multiple domains, including text classification, image classification, image object detection, data prediction, language understanding, text generation and the like. The system autonomously determines the applicable machine learning domain by analyzing data annotations, eliminating the need for manual domain specification. Furthermore, the system prunes redundant data elements, normalizes data quantities across classes to reduce training biases, and augments data to achieve enhanced accuracy with limited available samples. The automated hyperparameter evaluation identifies optimal parameters such as learning rate, batch size, choice of optimizer, regularization techniques and the like, significantly reducing manual tuning efforts. The system implements batch normalization to accelerate the training of the machine learning model, employs transfer learning to reduce processing times, and utilizes the adaptive learning rate schedulers to enhance model convergence. Additionally, the evaluation and benchmarking module continuously monitors performance metrics, implementing early stopping mechanisms to prevent overfitting, and provides objective summaries with benchmarks upon completion. Thus, the system substantially enhances consistency, reduces development time from concept to completion, further enhances the automated machine learning model quality and reliability, and makes advanced machine learning capabilities accessible.

In another aspect a method for automated model training includes receiving multi-modal input training data and user-defined parameters through an end-user abstraction interface, dynamically determining a machine learning domain applicable to the multi-modal input data by analyzing data annotations and autonomously pruning redundant data elements from the multi-modal input data to generate a training dataset. Furthermore, the method includes automatically identifying hyperparameters for the training dataset, automatically splitting the multi-modal input data into a plurality of data groups using predetermined split ratios, autonomously selecting a machine learning framework and neural network architecture based on the most appropriate machine learning domain, performing batch normalization on the training dataset, training a machine learning model using the training dataset, the selected framework and architecture, and the identified hyperparameters, wherein the training includes dynamic adjustment of learning rates and evaluating the machine learning model during training using validation data from the plurality of data groups, wherein training is terminated when the loss function indicates the minimal reduction in the difference between an actual and a predicted values over a plurality of training iterations.

The method achieves all the advantages and technical effects of the system of the present disclosure.

It is to be appreciated that all the aforementioned implementation forms can be combined. All steps that are performed by the various entities described in the present application, as well as the functionalities described to be performed by the various entities, are intended to mean that the respective entity is adapted to or configured to perform the respective steps and functionalities. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a network diagram of a system for an automated machine learning model training, in accordance with an embodiment of the present disclosure;

FIG. 2 is a block diagram of the system for the automated machine learning model training, in accordance with an embodiment of the present disclosure;

FIG. 3 is a flowchart of the method for the automated machine learning model training, in accordance with an embodiment of the present disclosure; and

FIG. 4 is an exemplary diagram that depicts the automated machine learning model training, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

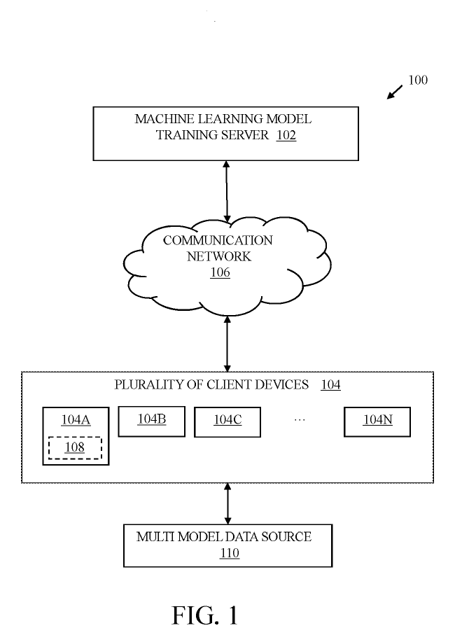

FIG. 1 is a network diagram of the system for the automated machine learning model training, in accordance with an embodiment of the present disclosure. With reference to FIG. 1, there is shown a network diagram of a system 100, which includes a machine learning model training server 102, a plurality of client devices 104, a communication network 106, a user interface 108, and a multi-modal data source 110.

The machine learning model training server 102 is the automated machine learning model training system, which is configured to provide end-to-end automation for training the machine learning models by receiving multi-modal input data, determining an applicable machine learning domain, preprocessing data, selecting optimal hyperparameters, and dynamically managing training processes. The machine learning model training server 102 reduces manual intervention in the machine learning model training system by automating data preprocessing, feature selection, hyperparameter tuning, and the automated machine learning model evaluation, and adapts to various machine learning applications, ensuring the optimized automated machine learning model performance and reliability.

The plurality of client devices 104 (i.e., a first client device 104A, a second client device 104B, a third client device 104C, and an nth client device 104N) is configured to interact with the machine learning model training server 102 through the user interface 108, allowing users to input data, configure training parameters, and retrieve the trained machine learning models. The plurality of client devices 104 communicates with the machine learning model training server 102 over the communication network 106, ensuring accessibility and usability across different platforms of the machine learning model training.

The communication network 106 is configured to enable unified data exchange between the machine learning model training server 102 components and the plurality of client devices 104. The communication network 106 supports data transmission, the machine learning model updates, and remote access, ensuring collaboration and execution of machine learning training workflows.

The user interface 108 is configured to provide interaction between a user and the machine learning model training server 102 by enabling the input of the multi-modal data and user-defined parameters without requiring in-depth technical knowledge. The user interface 108 abstracts the complexities of the machine learning model training, translating high-level user inputs into structured configurations for automated processing by the machine learning model training server 102.

The multi-modal data source 110 provides the input data used by the machine learning model training server 102, which may include various types of data such as text, images, or structured data across different domains including text classification, image classification, and object detection.

There is provided the system 100 that is configured to receive the multi-modal data and the user-defined parameters through the user interface, then perform a series of automated steps without requiring technical expertise. Moreover, the system 100 automates the machine learning training process across various domains, such as text classification, image classification, object detection, data prediction, text generation, language understanding and the like leading to efficient and accurate machine learning models for real-world applications. Furthermore, the system 100 includes the autonomous machine learning domain determination and hyperparameter optimization techniques for the automated machine learning model development. The system 100 enhances the efficiency of the training for the automated machine learning model, whereby autonomously determining the appropriate machine learning domain by analyzing data annotations and pruning redundant data elements. The system 100 preserves required information while removing overlapping elements that could hamper the fast automated machine learning model convergence to avoid manual intervention in the machine learning domain selection and data preprocessing that often leads to suboptimal results. Furthermore, training with automated batch normalization and adaptive learning rate scheduling exposes the automated machine learning model to optimized training conditions without requiring deep technical expertise. Additionally, the system 100 forms a high-performance machine learning model across the different machine learning domains while reducing training biases and preventing overfitting, leading to improved generalizability without increasing implementation complexity and development time. Furthermore, by selectively normalizing data quantity across classes through augmentation, the system 100 requires less original training data while maintaining the automated machine learning model quality.

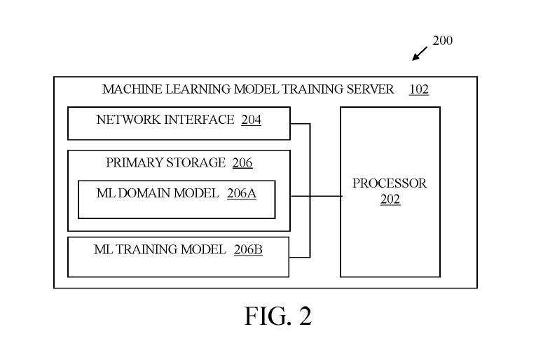

FIG. 2 is a block diagram of the system for the automated machine learning model training, in accordance with an embodiment of the present disclosure. With reference to FIG. 2, there is shown a block diagram of the system 100 for the automated machine learning model training 200, which includes a processor 202, a network interface 204 and a primary storage 206.

The processor 202 is configured to determine the applicable machine learning domain by analyzing data annotations, extracting features, and identifying patterns for optimal model selection. Examples of the processor 202 include a microprocessor, a microcontroller, an application-specific integrated circuit (ASIC), or other computing units capable of handling complex data processing tasks and optimization algorithms. In an implementation, the one or more processors can be used to determine the applicable machine learning domain by analyzing data annotations, extracting features, and identifying patterns for optimal model selection.

The network interface 204 is used to allow the processor 202 to communicate with the primary storage 206. Moreover, examples of implementation of the network interface 204 may include but are not limited to a network interface, a computer port, a network socket, a network interface controller (NIC), and any other network interface device.

The primary storage 206 acts as the system 100 central memory component, providing data storage and retrieval for the automated machine learning model training. The primary storage 206 includes different memory units, such as volatile and non-volatile memory, to support various operational requirements. Moreover, the primary storage 206 further contains an ML Domain Model 206A, which is a storage component within the primary storage 206 that retains information related to the ML domain determination. In an implementation, Moreover, the primary storage 206 further contains a meta model which is a storage component within the primary storage 206 that retains information related to the ML domain determination. The ML Domain Model 206A or meta model for determination of the domain stores pre-processed data, domain classification rules, feature extraction patterns, and metadata, enabling the processor 202 to identify the required machine learning domain based on input data characteristics. Furthermore, the primary storage 206 includes an ML Training Model 206B, which is a storage component within the primary storage 206 that holds training models, hyperparameters, optimization algorithms, and historical training data. The ML Training Model 206B provides the iterative machine learning model refinement, validation, and performance tracking to enhance the accuracy and efficiency of the automated machine learning model training workflows.

There is provided the system 100 for the automated machine learning model training that includes the processor 202 which is configured to receive the multi-modal input data and the user-defined parameters through the end-user abstraction interface. The multi-modal input data includes formats, such as text, images, numerical datasets, audio, sensor data and the like while the user-defined parameters, such as the automated machine learning model preferences, optimization constraints, the automated machine learning model training objectives and the like enabling customization of the automated machine learning model training workflow. Moreover, the processor 202 is configured to automate data handling by analyzing, validating, and standardizing the received multi-modal input data, ensuring compatibility with the selected machine learning models. The processor 202 is further configured to interact with the end-user abstraction interface, extracting relevant metadata, structuring data, and mapping the data to the required machine-learning model pipelines based on the user-defined parameters. Thereby, the system 100 enhances usability, reduces manual intervention, optimizes preprocessing, and ensures efficient training execution, making the automated machine learning model training accessible, scalable, and adaptable for various applications.

Furthermore, the processor 202 is configured to autonomously determine the machine learning domain applicable to the multi-modal input data by analyzing data annotations and autonomously pruning redundant data elements from the multi-modal input data to generate a training dataset. Determining the appropriate machine learning domain and eliminating redundant data is required to reduce computational complexity, enhance the automated machine learning model accuracy and streamline the automated machine learning model training process. Furthermore, the processor 202 is configured to analyse the data annotations to determine the required machine learning domain, utilizing techniques, such as metadata extraction, statistical correlation, clustering models and the like. Based on the identified machine learning domain, the processor 202 dynamically adjusts a preprocessing pipeline by selecting the machine learning domain-specific transformations. In an example, for text-based datasets, the processor 202 utilizes tokenization and word embeddings, while for image datasets, the processor 202 is configured to utilize feature extraction and normalization. Simultaneously, the processor 202 is configured to prune redundant data elements utilizing various techniques, such as correlation filtering, dimensionality reduction, and autonomous detection techniques. In an example, the processor 202 is configured to employ Principal Component Analysis (PCA) and autonomous feature selection algorithms to eliminate unnecessary attributes and ensure that the training dataset is refined, computationally efficient, and optimized for the accurate automated machine learning model training. The automation of the machine learning model enhances the machine learning model performance, reduces data processing overhead, and enables scalable and efficient training workflows across the machine learning applications.

Furthermore, the processor 202 is configured to automatically identify hyperparameters for the training dataset and automatically split the multi-modal input data into a plurality of data groups using dynamically determined split ratios. The hyperparameter selection and the data splitting are required to enhance the automated machine learning model performance which ensures efficient training of the automated machine learning model while preventing overfitting and underfitting of the automated machine learning model. In the system 100 the processor 202 is configured to analyse the dataset properties, such as feature distribution, dataset size, class imbalances and the like to determine the optimal hyperparameters, such as learning rate, batch size, regularization parameters and the like. Moreover, the processor 202 utilizes data-driven optimization techniques, such as Bayesian Optimization, Grid Search, Reinforcement Learning and the like to iteratively refine the hyperparameters. Simultaneously, the processor 202 dynamically splits the multi-modal input data into the plurality of data groups for training of the automated machine learning model, validation, and testing using adaptive split ratios. The processor 202 is configured to provide stratified sampling for categorical data, distribution-aware partitioning and cross-validation-based methods to ensure that each data group maintains statistical consistency and represents the dataset accurately. By automating the hyperparameter identification and the adaptive data splitting, the system 100 enhances the automated machine learning model generalization, reduces computational overhead, and ensures efficient and scalable machine learning training workflows across different datasets.

Furthermore, the processor 202 is configured to select a machine learning framework and neural network architecture based on the determined machine learning domain and perform batch normalization on the training dataset. Furthermore, the processor 202 is configured to analyse the characteristics of the identified machine learning domain, including the multi-modal input data format, computational complexity, and the automated machine learning model requirements. Based on the analysis, the processor 202 matches the machine learning domain with the predefined machine learning framework, and compatibility criteria and automatically selects the most suitable machine learning framework for training the machine learning model. Similarly, the processor 202 is configured to evaluate the data structure, feature dependencies, and task type to determine the required neural network architecture. Once selected, the processor 202 configures a neural network layer, activation functions, and optimization parameters to ensure alignment with the chosen machine learning framework. Furthermore, the processor 202 utilizes batch normalization to the training dataset, ensuring that the neural network layers receive standardized inputs. By automating the machine learning framework selection, the neural network architecture determination, and the batch normalization, the system 100 optimizes the automated machine learning model training workflows, reduces manual effort, and ensures the automated machine learning model generalization across different machine learning applications.

Furthermore, the processor 202 is configured to train the machine learning model using the training dataset, the selected framework and architecture, and the identified hyperparameters. The processor 202 utilizes the pre-processed training dataset, ensuring that the pre-processed data set aligns with the selected machine learning framework and the neural network architecture. The processor 202 further utilizes the identified hyperparameters, such as learning rate, batch size, regularization parameters and the like, to optimize the machine learning model training process. During training, the processor 202 performs iterative weight adjustments using gradient-based optimization techniques (i.e., Stochastic Gradient Descent (SGD), Adam, or RMSprop and the like) to minimize the loss function and improve the automated machine learning model accuracy. Additionally, the processor 202 continuously monitors the training progress, evaluating metrics such as validation loss and accuracy, and dynamically adjusts training parameters to prevent overfitting or underfitting. By automating the training process using the selected machine learning framework, the neural network architecture, and the hyperparameters, the system 100 ensures the efficient automated machine learning model convergence, reduces manual intervention, and optimises the automated machine learning model performance.

Furthermore, the training includes dynamic adjustment of learning rates and evaluating the machine learning model during training using validation data from the plurality of data groups. The processor 202 is configured to utilize identified learning rates to optimize the convergence of the automated machine learning model. During training, the processor 202 is configured to dynamically adjust the learning rates using adaptive learning rate techniques, such as learning rate decay, step decay, cyclical learning rates, adaptive optimizers and the like to enhance the automated machine learning model stability and prevent issues like overshooting or slow convergence. Additionally, the processor 202 evaluates the automated machine learning model at predefined intervals using validation data extracted from the plurality of data groups, such as training-validation splits, cross-validation sets, holdout validation sets and the like. Furthermore, the processor 202 is configured to monitor the automated machine learning model performance metrics including validation loss, accuracy, and generalization error. Based on the evaluation results, the processor 202 fine-tunes training parameters, adjusts regularization techniques, applies early stopping mechanisms if required and enhances the training efficiency of the automated machine learning model.

Furthermore, when the training is terminated a loss function indicates the minimal reduction in the difference between an actual and a predicted value. Furthermore, the loss function acts as an indicator of the automated machine learning model optimization, measuring the discrepancy between the predicted value outputs and ground truth values. The processor 202 continuously evaluates the loss function trend during the automated machine learning model training and detects plateauing behaviour where further optimization provides negligible improvements. The processor 202 is configured to utilize early stopping mechanisms by monitoring criteria such as loss stagnation over multiple epochs, minimal gradient updates, convergence thresholds and the like. Upon detecting a minimal reduction in loss over successive training iterations, the processor 202 automatically terminates the machine learning model training, preventing unnecessary computations and ensuring the efficiently trained automated machine learning model. By incorporating the loss-based termination, the system 100 enhances the automated machine learning model training efficiency, prevents overfitting, and optimizes resource utilization across different machine learning applications.

In accordance with an embodiment, the machine learning domain is automatically determined from a group consisting of semantic content categorization, visual pattern recognition, and multi-dimensional spatial entity identification. The processor 202 is configured to analyse the multi-modal input data, such as text, images, numerical data, spatial representations, and the like, to identify inherent patterns, feature distributions, and contextual relationships. The processor 202 determines the machine learning domain by extracting attributes from the multi-modal input data, such as word embeddings for text, edge detection for images, numerical correlations for structured data, and spatial positioning for multi-dimensional entities. Once the relevant features are extracted, the processor 202 utilizes the metadata extraction, statistical correlation analysis, and clustering techniques to classify the dataset into the required machine learning domain. For semantic content categorization, the processor 202 identifies textual structures, linguistic patterns, contextual semantics and the like by utilizing natural language processing (NLP) techniques, including tokenization, part-of-speech tagging, entity recognition and like to understand textual relationships. In visual pattern recognition, the processor 202 detects spatial arrangements, feature embeddings, and object relationships. To attain the same, the processor 202 employs convolutional neural networks (CNNs), edge detection algorithms, and feature maps to identify visual patterns. For multi-dimensional spatial entity identification, the processor 202 analyses geometric configurations, topological dependencies, and spatial distributions. By automating the machine learning domain determination, the system 100 enhances the automated machine learning model training efficiency while ensuring the optimal machine learning domain-specific model selection across various applications.

In accordance with an embodiment, the system 100 extracts features from the data annotations and further analyses the extracted features to identify patterns indicative of specific machine learning domains and select the machine learning domain based on the identified patterns. The processor 202 is configured to retrieve the data annotations containing metadata, labels, other structural information and the like and extracts relevant features from the data annotations. Furthermore, the processor 202 utilizes the statistical correlation analysis, the clustering models, embedding-based techniques and the like to analyse the extracted features and detect characteristic patterns associated with the specific machine learning domains. Once the indicative patterns are identified, the processor 202 maps the dataset to the suitable machine learning domain, such as semantic content categorization, visual pattern recognition, multi-dimensional spatial entity identification and the like. By automating the feature extraction, the pattern identification, and the machine learning domain selection, the system 100 enhances efficiency while ensuring the optimal machine learning domain selection.

In accordance with an embodiment, the system 100 removes overlapping data elements to compute similarity scores between data elements, identify data elements having similarity scores exceeding a threshold value and intelligently prune the identified data elements from the training dataset. The processor 202 is configured to process the training dataset to extract the feature representations of each data element, ensuring that both structured and unstructured data are considered. The Processor 202 then applies similarity measurement techniques, such as cosine similarity for text-based data, Jaccard index for categorical attributes, and Euclidean distance for numerical data and the like to compute similarity scores between the data elements. Once similarity scores are calculated, the processor 202 compares the similarity scores against the predefined threshold value to determine if any two or more data elements are excessively similar or redundant. If the similarity score exceeds the threshold, the processor 202 marks the elements as overlapping. Furthermore, to prune the identified overlapping data elements, the processor 202 utilizes redundancy filtering techniques, such as clustering-based selection, statistical outlier detection methods and the like. For example, if multiple data points are found to be nearly identical, the processor 202 retains the most representative sample while discarding the redundant ones. Additionally, the clustering-based techniques group similar data points and remove unnecessary repetitions, ensuring that dataset diversity is preserved. By automating the overlapping data removal, the system 100 optimizes dataset quality, enhances training efficiency, and reduces storage overhead while preventing redundant information from negatively impacting the automated machine learning model performance.

In accordance with an embodiment, the system 100 automatically splits the multi-modal input data, to calculate class distribution statistics for each class in the multi-modal input data and applies predetermined split ratios specific to the determined machine learning domain, in which, the split ratios are stored values derived from historical performance analysis of similar machine learning tasks. The processor 202 is configured to analyse the multi-modal input data to calculate class distribution statistics, including the frequency, variance, imbalance levels and the like of each class present in the dataset. The processor 202 then evaluates data characteristics such as skewness, sparsity, and representation density, to ensure an optimal split strategy. Based on the calculated class distribution, the processor 202 retrieves predefined split ratios that have been historically derived from the similar machine learning tasks for the same machine learning domain within the same system. The past stored split ratios act as reference values, ensuring that the training, validation, and test datasets are allocated in a manner that optimizes the automated machine-learning model generalization and minimizes bias. To impose the machine learning domain-specific split ratios, the processor 202 is configured to apply adaptive partitioning techniques, such as stratified sampling for imbalanced datasets, random sampling for uniformly distributed data, and cluster-based sampling for structured datasets. The processor 202 ensures that each subset maintains statistical consistency with the original dataset while maximizing the automated machine learning model's ability to learn required patterns. By automating class distribution analysis and applying historical split ratios, the system 100 enhances data balance, enhances the automated machine learning model accuracy, and ensures optimal training efficiency for the different machine learning domains.

In accordance with an embodiment, the processor 202 is further configured to employ a deterministic pseudorandom operation with a fixed seed value to ensure reproducibility of data splits and maintain proportional class distribution across all data groups to mitigate training bias. The processor 202 is configured to initialise the fixed seed value, ensuring that every time the data is split, the same sequence of partitions is generated, allowing for consistent training, validation, and testing sets. The processor 202 then extracts class distribution statistics from the multi-modal input data, calculating the frequency of each class to prevent imbalances in the dataset. Using the predefined seed value, the processor 202 applies deterministic sampling techniques, such as stratified sampling, weighted random sampling and the like to allocate data elements to different subsets while maintaining the same proportional class representation in each group to prevent scenarios where minority class samples are disproportionately assigned to a specific subset, which could otherwise lead to biased learning. By automating structured data partitioning, the system 100 enhances the machine learning model reliability, enables consistent performance benchmarking, and ensures unbiased learning across diverse machine learning tasks.

In accordance with an embodiment, the processor 202 is further configured to normalize data quantity across classes through data augmentation based on selection from the plurality of data groups to reduce training biases. The processor 202 is configured to analyse the class distribution statistics, to detect class imbalances within the dataset. If a class has significantly fewer samples compared to others, the processor 202 applies data augmentation techniques, such as synthetic data generation, oversampling, transformation-based augmentation and the like to artificially expand the underrepresented class. The data augmentation process includes geometric transformations for image data, paraphrasing for text data, perturbation techniques for numerical datasets and any other data augmentation based on the multi-modal data input. Additionally, the processor 202 selects relevant samples from other data groups within the dataset to supplement the minority class, ensuring that class distributions remain balanced across training, validation, and testing phases. By automating data normalization and augmentation, the system 100 reduces the automated machine learning model overfitting to dominant classes and enhances generalization across various machine learning applications.

In accordance with an embodiment, the system 100 performs batch normalization to standardize input distributions across mini-batches to optimize the learning process. Batch normalization is required to stabilize the training of the automated machine learning model by ensuring that the multi-modal data input feature distributions remain consistent, reducing internal covariate shifts and accelerating the automated machine learning model convergence. Moreover, the processor 202 computes the mean and variance of each mini-batch, normalizing the multi-modal data inputs by subtracting the mean and scaling based on the standard deviation. The processor 202 then applies learnable scaling (γ) and bias (β) parameters to rescale and shift the normalized values, allowing the automated machine learning model to retain expressive feature representations. The parameters are updated during backpropagation, dynamically adjusting at each training step to accommodate variations in input distributions. Additionally, the processor 202 employs momentum-based moving averages or adaptive normalization techniques to further stabilize learning across different mini-batches. Thereby, the batch normalization in the system 100 enhances the automated machine learning model stability, accelerates convergence, and reduces sensitivity to weight initialization, leading to more reliable and efficient training of the automated machine learning model. Additionally, the batch normalization minimizes the need for manual hyperparameter tuning, making deep learning models more adaptable and scalable across different datasets and architectures.

In accordance with an embodiment, the system 100 trains the machine learning model, to implement an adaptive learning rate scheduler that adjusts the learning rate when training metrics plateau. Learning rate scheduling is required to optimize the automated machine learning model convergence, as the constant learning rate either slows down the training of the automated machine learning model or ensures instability, preventing efficient learning. The processor 202 is configured to continuously monitor training metrics and detect when improvements decline. When the plateau is identified, the processor 202 reduces the learning rate using techniques such as step decay, exponential decay and the like that ensure the automated machine learning model fine-tunes parameters more effectively. The processor 202 dynamically adjusts the learning rate at predefined intervals and in response to performance thresholds, preventing overshooting while maintaining efficient training progression. Thereby, the adaptive learning rate scheduler in the system 100 enhances the automated machine learning model training efficiency, prevents prolonged stagnation, and ensures optimal convergence rates across diverse machine learning tasks. The automation reduces manual hyperparameter tuning and enhances the automated machine learning model generalization while leading to faster and more stable training outcomes of the automated machine learning model.

In accordance with an embodiment the system 100 evaluates the machine learning model to calculate loss values using the validation data and comparing current loss values to previous loss values. The automated machine learning model evaluation is required to assess training progress and ensure that the automated machine learning model generalizes well to unseen data. If loss values are not systematically monitored, the automated machine learning model overfit or underperforms, leading to unreliable predictions. Furthermore, the processor 202 computes the loss function on validation data at regular intervals, capturing discrepancies between predicted and actual values. The processor 202 then compares the current loss values to previously recorded loss values from earlier training iterations to detect trends in the automated machine learning model performance. If the validation loss remains stable or decreases, the processor 202 indicates effective learning, whereas an increase in validation loss signals overfitting or reduced generalization. By automating the loss evaluation through continuous validation-based monitoring, the system 100 enhances the automated machine learning model reliability, prevents unnecessary overtraining, and ensures that training adjustments are made proactively to enhance the performance of the automated machine learning model.

In accordance with an embodiment, the system 100 augments data to alter original data through techniques specific to the determined machine learning domain while preserving semantic meaning of the original data. Data augmentation is required for enhancing the automated machine learning model generalization, particularly in cases where training data is limited or imbalanced. Without proper augmentation, the automated machine learning models struggle to learn diverse feature representations, leading to a lack of performance on unseen data. Furthermore, the processor 202 is configured to apply augmentation techniques to the identified machine learning domain. For image-based models, the processor 202 performs transformations, such as rotation, flipping, scaling, or contrast adjustments while ensuring that object relationships remain intact. For text-based models, augmentation includes synonym replacement, back translation, or sentence paraphrasing, preserving the original intent. In numerical datasets, the processor 202 introduces controlled perturbations, interpolation techniques, or feature-space augmentations to generate varied yet meaningful training samples. By ensuring that the augmented data retains semantic integrity, the processor 202 maintains consistency in the automated machine learning model learning while increasing dataset diversity. By automating the machine learning domain-specific data augmentation, the system 100 enhances the automated machine learning model adaptability, prevents overfitting, and enhances learning efficiency across different machine learning applications.

Advantageously, the system 100 is configured to provide the automated and optimized method for training the machine learning models across multiple domains, including text classification, image classification, image object detection and the like. The system 100 autonomously determines the applicable machine learning domain by analyzing data annotations, eliminating the need for manual domain specification. Furthermore, the system 100 prunes redundant data elements, normalizes data quantities across classes to reduce training biases, and augments data to achieve enhanced accuracy with limited available samples. The automated hyperparameter evaluation identifies optimal parameters such as learning rate, batch size, regularization techniques and the like, significantly reducing manual tuning efforts. The system 100 implements batch normalization to accelerate the training of the automated machine learning model, employs transfer learning to reduce processing times, and utilizes the adaptive learning rate schedulers to enhance convergence. Additionally, the evaluation and benchmarking module continuously monitors performance metrics, implementing early stopping mechanisms to prevent overfitting, and provides objective summaries with benchmarks upon completion. Thus, the system 100 substantially enhances consistency, reduces development time from concept to deployment, further enhances the automated machine learning model quality and reliability, and makes advanced machine learning capabilities accessible to users without specialized domain knowledge.

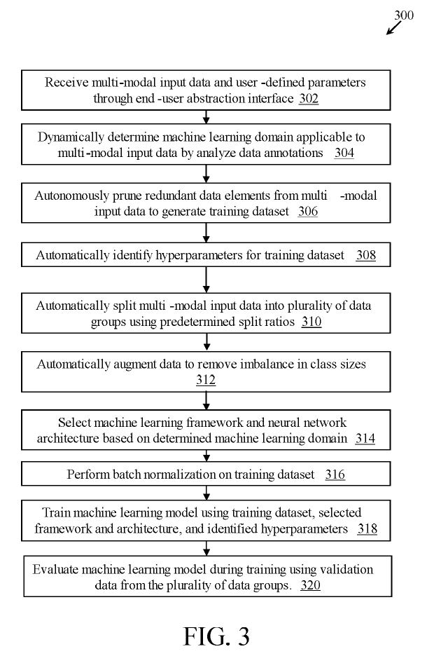

FIG. 3 is a flowchart of a method for the automated machine learning model training, in accordance with an embodiment of the present disclosure. With reference to FIG. 3, there is shown a flowchart of a method 300 that includes steps 302-to-318. The system 100 (of FIG. 1) is configured to execute method 300.

There is provided a method 300 for the automated machine learning model training. At step 302, the method 300 includes receiving multi-modal input data and user-defined parameters through an end-user abstraction interface. At step 304, the method 300 includes dynamically determining the machine learning domain applicable to multi-modal input data by analyzing data annotations. At step 306, the method 300 includes autonomously pruning redundant data elements from multi-modal input data to generate a training dataset. At step 308, the method 300 includes automatically identifying hyperparameters for the training dataset. At step 310, the method 300 includes automatically splitting multi-modal input data into the plurality of data groups using predetermined split ratios. At step 312, the method 300 includes automatically augmenting data to remove imbalance in class sizes. At step 314, selecting a machine learning framework and neural network architecture based on the determined machine learning domain. In an implementation, the method 300 includes the meta-model to determine an appropriate model architecture and training framework. At step 316, the method 300 includes performing batch normalization on the training dataset. At step 318, the method 300 includes identify hyperparameters using a meta-model for training the machine learning models using a training dataset, selected framework and architecture, and identified hyperparameters. Finally, at step 320, the method 300 includes evaluating the machine learning model during training using validation data from the plurality of data groups.

In accordance with an embodiment, the method 300 determining the machine learning domain includes analyzing annotation formats to identify the presence of positional coordinates indicative of object detection tasks, analyzing text annotations to determine if they represent classification labels or generation prompts and determining the machine learning domain based on the analysis of the annotation formats. The processor 202 is configured to extract the annotation metadata from the multi-modal input data, analyzing structural attributes such as format type, embedded metadata, and content patterns. For image-based annotations, the processor 202 detects positional coordinates, including bounding box coordinates, pixel masks, and markers, using spatial analysis techniques and feature extraction models. If positional data is present, the processor 202 classifies the dataset under object detection, segmentation, or related spatial tasks. For text annotations, the processor 202 tokenizes and parses annotation content, applying a natural language processing (NLP) technique such as a named entity recognition (NER) and syntactic analysis to determine whether the text represents classification labels (i.e., structured tags linked to predefined categories) or generation prompts (i.e., free-form text used for generative models). The processor 202 compares the annotation format and extracted text structure against predefined rules and the machine learning domain mappings to assign the dataset to the most relevant domain. By automating annotation analysis and the machine learning domain classification, the system 100 ensures accurate dataset categorization, reduces the need for manual intervention, and optimizes the automated machine learning model selection for diverse machine learning tasks that enhance the training efficiency, improve the automated machine learning model adaptability, and ensures compatibility with the domain-specific processing techniques.

In accordance with an embodiment, the method 300 for the automated machine learning model training identifies hyperparameters that include using a meta-model incorporating statistical methods and prior training data to determine optimal hyperparameters for fast model convergence. The processor 202 is configured to apply the meta-model framework that controls the historical training data and statistical analysis to optimize the hyperparameter selection. The processor 202 retrieves prior training data, including past hyperparameter configurations and corresponding the machine learning model performance metrics. The processor 202 then applies statistical techniques, such as Bayesian Optimization, Gaussian Processes, regression-based models and the like to analyse correlations between the hyperparameters and the automated machine learning model convergence rates the processor 202 then predicts the optimal set of hyperparameters, including learning rate, batch size, regularization parameters, and weight initialization strategies, to accelerate the automated machine learning model training. The meta-model continuously refines the predictions by incorporating feedback from new training runs, ensuring that hyperparameter selection adapts dynamically to different datasets and the automated machine learning model architectures. By automating the hyperparameter identification through the meta-model, the system 100 significantly reduces manual tuning efforts, enhances training efficiency, and ensures faster convergence with the enhanced automated machine learning model stability.

In accordance with an embodiment, the method 300 automatically splits the multi-modal input data that includes computing similarity factors between data samples using embedding models that map high-dimensional data to lower-dimensional vector spaces, analyzing the data characteristics to determine if sufficient data exists for each class, selecting appropriate split ratios based on prior knowledge of split ratios versus output accuracy for the determined machine learning domain and adjusting the splits when insufficient data is detected including implementing data augmentation to fulfil minimum data requirements. The processor 202 is configured to compute similarity factors between data samples by utilizing embedding models, which transform high-dimensional data into lower-dimensional vector representations while preserving semantic relationships. The processor 202 calculates pairwise similarity scores using techniques such as cosine similarity and the like, identifying clusters of similar data points and ensuring that each split maintains diversity and representation balance. Furthermore, the processor 202 analyses the dataset characteristics by evaluating class distributions, feature variances, and instance frequencies. The processor 202 determines whether sufficient data exists for each class by setting a predefined minimum threshold for representation. If any class lacks adequate samples, the processor 202 flags for augmentation and alternative adjustments. Moreover, the processor 202 then selects the optimal split ratios by referencing a knowledge base containing prior performance metrics correlating split ratios with the automated machine learning model accuracy across different machine learning domains enabling the processor 202 to assign appropriate proportions of training, validation, and test data in a way that enhances the automated machine learning model generalization while preventing overfitting or underfitting. If insufficient data is detected, the processor 202 dynamically adjusts the splits by either redistributing available samples or applying data augmentation techniques such as synthetic data generation, oversampling, or transformations to meet minimum data requirements. The augmentation methods utilized are machine learning domain-specific, ensuring that data integrity and semantic meaning are preserved while increasing dataset diversity.

In accordance with an embodiment, the method 300 provides an objective summary of evaluation metrics with benchmarks upon completion of the training process. The processor 202 collects and compiles the evaluation metrics, such as accuracy, precision, recall, F1-score, loss values, and the automated machine learning model convergence rates, at the end of the training process. The processor 202 then compares the metrics against predefined benchmark values stored in the system 100, which includes the historical performance data, industry-standard benchmarks and the machine learning domain-specific thresholds. Using statistical analysis and the like, the processor 202 identifies performance trends, detects deviations, and highlights areas for improvement by assessing whether the trained automated machine learning model meets or exceeds expected performance standards. The summary also includes visual representations, such as graphs and comparative tables, for clearer insights. By automating the generation of the objective performance summary, the system 100 enables the efficient automated machine learning model evaluation, facilitates informed decision-making, and ensures transparency in the automated machine learning model performance assessments.

In accordance with an embodiment, the method 300 includes selecting the framework and architecture that includes evaluating appropriate training frameworks based on compatibility with the determined machine learning domain, selecting an architecture based on the size and characteristics of the available dataset and configuring the selected architecture with the identified hyperparameters. The processor 202 evaluates the available machine learning framework by assessing the computational efficiency, scalability, and compatibility with the determined machine learning domain. The processor 202 then analyses the dataset characteristics, including size, feature complexity, distribution and the like to select the appropriate automated machine learning model architecture. In an example, the CNNs chosen for image processing, a Recurrent Neural Network (RNN) for sequential data, and transformer-based models for NLP tasks. Once the architecture is selected, the processor 202 is configured with the identified hyperparameters, such as the learning rate, the batch size, and the regularization parameters, ensuring optimized performance and accelerated convergence. By automating the framework selection, the architecture determination, and the hyperparameter configuration, the system 100 enhances the training efficiency while improving the automated machine learning model adaptability across diverse machine learning applications.

In accordance with an embodiment, the method 300 includes using transfer learning to reduce training time when applicable to the determined machine learning domain and available data. The processor 202 is configured to determine whether the transfer learning is applicable by analyzing the machine learning domain, dataset size, and feature similarity to pre-trained models. If applicable, the processor 202 selects a pre-trained model from a compatible framework, such as ResNet, VGG and the like for image classification, BERT for NLP tasks, or pre-trained GANs for generative models. The processor 202 then extracts the relevant layers from the pre-trained model and fine-tunes the extracted relevant layers using the available dataset while modifying earlier layers to retain general feature representations. Additionally, the processor 202 adjusts learning rates, batch normalization parameters, and optimization techniques to ensure efficient adaptation to the new dataset. By utilizing the transfer learning, the system 100 significantly reduces the training time, minimizes computational overhead, and enhances the automated machine learning model generalization, especially in scenarios with limited training data

In accordance with an embodiment, the method 300 includes the machine learning domain which is automatically determined without explicit specification by a user. The processor 202 analyses the multi-modal input data by extracting metadata, feature distributions, annotation structures and the like to infer the required machine learning domain based on the multi-modal input data. The processor 202 identifies patterns in the data, such as spatial coordinates in images for object detection, sequential dependencies in text for NLP tasks, or numerical trends for predictive modelling. The processor 202 then utilizes classification algorithms, statistical correlation techniques, clustering models and the like to match the dataset with the appropriate machine learning domain. The automated process eliminates the need for user intervention, ensuring that the automated machine learning model training pipeline is aligned with the dataset characteristics without requiring manual domain specification. Moreover, by automating the machine learning domain determination, the system 100 enhances the training efficiency, reduces human errors, and optimizes the automated machine learning model selection for various applications.

In accordance with an embodiment, the method 300 normalises batches which includes determining optimal batch sizes based on the available computational resources, implementing batch normalization techniques specific to the selected architecture and optimizing memory usage during training based on the normalized batches and on historical data. The processor 202 is configured to evaluate the available computational resources, including GPU/CPU capacity, memory bandwidth, and parallel processing capabilities, to determine the optimal batch size that balances computational efficiency and training stability. The processor 202 then applies batch normalization techniques personalized to the selected architecture, such as layer normalization for transformers, instance normalization for style transfer models, standard batch normalization for CNNs and RNNs and the like ensuring that activations remain stable, and learning is accelerated. Additionally, the processor 202 analyses the historical training data to identify memory consumption patterns and dynamically adjusts the memory allocation to prevent bottlenecks, optimize resource utilization, and enhance training efficiency. By automating the batch size determination, architecture-specific normalization, and memory optimization, the system 100 ensures faster convergence, improved the automated machine learning model stability, and efficient utilization of hardware resources.

In accordance with an embodiment, the method 300 monitoring the training process includes tracking multiple loss metrics simultaneously, comparing current loss metrics against historical values and implementing early stopping with a configurable patience parameter to prevent overfitting. The processor 202 continuously monitors the multiple loss metrics, such as categorical cross-entropy, mean squared error, hinge loss and the like depending on the machine learning task. The processor 202 compares the current loss values with previously recorded loss metrics, analysing trends to detect the potential performance degradation or stagnation. If the loss values indicate diminishing improvements over a defined period, the processor 202 initiates the early stopping utilizing the configurable patience parameter, which determines the number of consecutive epochs without improvement before halting training. Additionally, the processor 202 adjusts learning dynamics by applying techniques, such as learning rate reduction or regularization tuning if loss stabilization occurs too early, ensuring efficient training without unnecessary overfitting. By automating the training monitoring, historical loss comparison, and adaptive early stopping, the system 100 ensures optimized training efficiency, prevents unnecessary computational resource consumption, and enhances the automated machine learning model generalization across various machine learning applications.

Advantageously, the method 300 is used to provide enhanced machine learning model development by automating the entire training workflow from data input to model evaluation, eliminating the need for manual intervention and specialized expertise. The ability to autonomously determine the appropriate machine learning domain, optimize hyperparameters, and implement adaptive training techniques allows the system 100 to support rapid development of high-quality machine learning models across multiple domains while reducing development time.

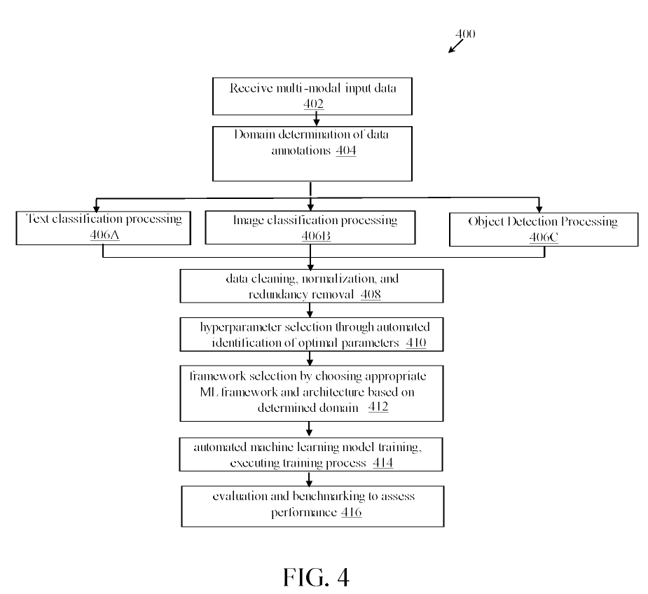

FIG. 4 is an exemplary diagram that depicts the automated machine learning model training, in accordance with an embodiment of the present disclosure. With reference to FIG. 4, there is shown the exemplary diagram 400 of the automated machine learning model training.

In an implementation scenario, the system 100 is configured to receive the multi-modal input data, such as at step 402. At step 404, the diagram 400 performs domain determination through automated analysis of data annotations. Based on the analysis, the workflow branches into three domain-specific pathways, such as step 406A for text classification processing, step 406B for image classification processing, and step 406C for object detection processing. Following the domain-specific branching, continues at step 408 with data preprocessing, which includes data cleaning, normalization, and redundancy removal. At step 410, the diagram 400 includes hyperparameter selection through automated identification of optimal parameters. At step 412, includes framework selection by choosing the appropriate ML framework and architecture based on the determined domain. At step 414, includes the automated machine learning model training, executing the training process with adaptive optimization techniques. Finally, at step 416 includes evaluation and benchmarking to assess performance and generate metrics reports of the automated machine learning model.

Advantageously, the processing pathways are configured to each machine learning domain, enabling optimized performance across different types of machine learning tasks. As a result, the system 100 is configured to ensure that text, image, and object detection data receive preprocessing, the hyperparameter selection, and architecture optimization without requiring the user to possess specialized knowledge of each domain for enhancing the automated machine learning model quality and training efficiency across multiple machine learning applications.

Modifications to embodiments of the present disclosure described in the foregoing are possible without departing from the scope of the present disclosure as defined by the accompanying claims. Expressions such as "including", "comprising", "incorporating", "have", "is" used to describe and claim the present disclosure are intended to be construed in a non-exclusive manner, namely allowing for items, components or elements not explicitly described also to be present. Reference to the singular is also to be construed to relate to the plural. The word "exemplary" is used herein to mean "serving as an example, instance or illustration". Any embodiment described as “exemplary” is not necessarily to be construed as preferred or advantageous over other embodiments and/or to exclude the incorporation of features from other embodiments. The word "optionally" is used herein to mean "is provided in some embodiments and not provided in other embodiments". It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

We claim:

1. A system for automated machine learning model training, comprising:
a processor configured to:
receive multi-modal input data and user-defined parameters through an end-user abstraction interface;
autonomously determine a machine learning domain applicable to the multi-modal input data by analyzing data annotations;
autonomously prune redundant data elements from the multi-modal input data to generate a training dataset;
automatically identify hyperparameters for the training dataset;
automatically split the multi-modal input data into a plurality of data groups using dynamically determined split ratios;
select a machine learning framework and neural network architecture based on the determined machine learning domain;
perform batch normalization on the training dataset;
train a machine learning model using the training dataset, the selected framework and architecture, and the identified hyperparameters, wherein the training includes dynamic adjustment of learning rates; and
evaluate the machine learning model during training using validation data from the plurality of data groups, wherein training is terminated when a loss function indicates minimal reduction in a difference between an actual and a predicted value.

2. The system as claimed in claim 1, wherein, the machine learning domain is automatically determined from a group consisting of semantic content categorization, visual pattern recognition, and multi-dimensional spatial entity identification.

3. The system as claimed in claim 1, wherein, in order to determine the machine learning domain, the processor is configured to:
extract features from the data annotations;
analyse the extracted features to identify patterns indicative of specific machine learning domains; and
select the machine learning domain based on the identified patterns.

4. The system as claimed in claim 1, wherein in order to remove overlapping data elements the processor is further configured to:
compute similarity scores between data elements;
identify data elements having similarity scores exceeding a threshold value; and
intelligently prune the identified data elements from the training dataset.

5. The system as claimed in claim 1, wherein, in order to automatically split the multi-modal input data, the processor is further configured to:
calculate class distribution statistics for each class in the multi-modal input data;
apply predetermined split ratios specific to the determined machine learning domain, wherein the split ratios are stored values derived from historical performance analysis of similar machine learning tasks;
employ a deterministic pseudorandom operation with a fixed seed value to ensure reproducibility of data splits; and
maintain proportional class distribution across all data groups to mitigate training bias.

6. The system as claimed in claim 1, wherein the processor is further configured to:
normalize data quantity across classes through data augmentation, based on selection from the plurality of data groups to reduce training biases.

7. The system as claimed in claim 1, wherein in order to perform batch normalization, the processor is configured to standardize input distributions across mini batches to optimize the learning process.

8. The system as claimed in claim 1, wherein, in order to train the machine learning model, the processor is configured to implement an adaptive learning rate scheduler that adjusts the learning rate when training metrics plateau.

9. The system as claimed in claim 1, wherein, in order to evaluate the machine learning model, the processor is configured to calculate loss values using the validation data and comparing current loss values to previous loss values.

10. The system as claimed in claim 9, wherein in order to augment data, the processor is further configured to:
alter original data through techniques specific to the determined machine learning domain while preserving semantic meaning of the original data.

11. A method for automated machine learning model training, comprising:
receiving multi-modal input data and user-defined parameters through an end-user abstraction interface;
dynamically determining a machine learning domain applicable to the multi-modal input data by analyzing data annotations;
autonomously pruning redundant data elements from the multi-modal input data to generate a training dataset;
automatically identifying hyperparameters for the training dataset;
automatically splitting the multi-modal input data into a plurality of data groups using predetermined split ratios;
selecting a machine learning framework and neural network architecture based on the determined machine learning domain;
performing batch normalization on the training dataset;
training a machine learning model using the training dataset, the selected framework and architecture, and the identified hyperparameters, wherein the training includes dynamic adjustment of learning rates; and
evaluating the machine learning model during training using validation data from the plurality of data groups, wherein training is terminated when the loss function indicates minimal reduction in the difference between an actual and a predicted value.

12. The method as claimed in claim 11, wherein determining the machine learning domain comprises:
analyzing annotation formats to identify presence of positional coordinates indicative of object detection tasks;
analyzing text annotations to determine if they represent classification labels or generation prompts; and
determining the machine learning domain based on the analysis of the annotation formats.

13. The method as claimed in claim 11, wherein identifying hyperparameters comprises:
using a meta model incorporating statistical methods and prior training data to determine optimal hyperparameters for fast model convergence.

14. The method as claimed in claim 11, wherein automatically splitting the multi-modal input data comprises:
computing similarity factors between data samples using embedding models that map high-dimensional data to lower-dimensional vector spaces;
analyzing the data characteristics to determine if sufficient data exists for each class;
selecting appropriate split ratios based on prior knowledge of split ratios versus output accuracy for the determined machine learning domain; and
adjusting the splits when insufficient data is detected including implementing data augmentation to fulfil minimum data requirements.

15. The method as claimed in claim 11, further comprising:
providing an objective summary of evaluation metrics with benchmarks upon completion of the training process.

16. The method as claimed in claim 11, wherein selecting the framework and architecture comprises:
evaluating available frameworks based on compatibility with the determined machine learning domain;
selecting an architecture based on the size and characteristics of the available dataset; and
configuring the selected architecture with the identified hyperparameters.

17. The method as claimed in claim 11, further comprising:
using transfer learning to reduce training time when applicable to the determined machine learning domain and available data.

18. The method as claimed in claim 11, wherein the machine learning domain is automatically determined without explicit specification by a user.

19. The method as claimed in claim 11, wherein normalizing batches comprises:
determining optimal batch sizes based on the available computational resources;
implementing batch normalization techniques specific to the selected architecture; and
optimizing memory usage during training based on the normalized batches and on historical data.

20. The method as claimed in claim 11, wherein monitoring the training process comprises:
tracking multiple loss metrics simultaneously;
comparing current loss metrics against historical values; and
implementing early stopping with a configurable patience parameter to prevent overfitting.
